(19) United States
(12) Patent Application Publication
(10) Pub. No.: US 2018/0344077 A1
(43) Pub. Date: Dec. 6, 2018

(54) A PIPE ARRANGEMENT FOR A FLUID HEATING ASSEMBLY, FLUID HEATING ASSEMBLY AND BEVERAGE PREPARATION MACHINE

(71) Applicant: NESTEC S.A., Vevey (CH)

(72) Inventors: Michael Ayoub, Crissler (CH); Nicolas Stoudmann, Cugy (CH)

(21) Appl. No.: 15/761,617

(22) PCT Filed: Sep. 20, 2016
(86) PCT No.: PCT/EP2016/072294

§ 371 Date: Mar. 20, 2018

(30) Foreign Application Priority Data
Sep. 22, 2015 (EP) 15186212.5

(51) Int. Cl. A47J 31/54; A47J 31/44; A47J 31/46; F24H 1/12

(52) U.S. Cl. CPC A47J 31/54; A47J 31/4421; F24H 1/145; F24H 1/121; A47J 31/465

(57) ABSTRACT

The invention relates to a pipe arrangement for a fluid heating assembly formed of a single heat conductive pipe (1), comprising a stack, along a main axis (A) of the arrangement, of elongate loops (L1, L2, L3, L4) of said pipe (1) extending radially from the main axis (A) in directions substantially orthogonal to said main axis (A). The extension directions of two successive loops form a substantially constant angle between them, and the parts of the loops (L1, L2, L3, L4), in the stack, that are proximal in relation to the main axis (A) define a central channel around the main axis (A). The invention also relates to a fluid heating assembly comprising such a pipe arrangement, and to a portable hot beverage preparation machine comprising this fluid heating assembly.

### FIELD OF THE INVENTION

The present invention concerns the technical field of hot beverage or food preparation devices, in particular autonomous devices in that they may produce the required heat without an external source of power such as mains electricity. More specifically, the invention preferably relates to portable devices (also called nomad devices), i.e. devices that can be easily carried by a user for beverage or food preparation for example when taking a break in a walk, when camping or bivouacking, sailing, or for any outdoor event.

### BACKGROUND OF THE INVENTION

The preparation of hot beverages and certain hot food products (soups, noodles, etc.) requires heating a fluid, generally water, to a sufficient temperature. For example, the preparation of coffee requires providing water heated to between 75° C. and 100° C. to extract the flavours from ground coffee. Ground coffee may be provided in capsules or other suitable packages, or in loose form to be disposed in a coffee filter for coffee preparation. Capsules or similar packages may be used to provide other ingredients for beverage or food preparation.

Although the invention is hereafter generally described in reference to the example of a coffee maker in which water has to be heated, it should be understood that the invention relates to any hot beverage preparation machine and to some food preparation machines for heating a liquid or pasty product.

One of the main difficulties when providing a portable and autonomous coffee preparation device is the production of hot water (or other fluid) from water at ambient temperature, with as little energy as possible (i.e. with the best possible heating efficiency) and in as short a time as possible.

Water may be heated in a tank, such as in a moka coffee maker. However, this implies that the tank contains the exact quantity of water needed for the preparation of the coffee, the entire quantity of water in the tank being heated, and that the tank has to be filled each time coffee has to be prepared.

Another approach is to heat the water when it passes in a pipe arrangement from a tank or a water source to the ground coffee. In other word, only the quantity of water that is pumped from the tank or water source is heated as the coffee is prepared. This approach is used in most home appliance for coffee making, using capsules or sachets of ground coffee, or coffee filters. However, portable devices have to be sufficiently compact to be easily carried by the user. The water (or other fluid) heating system used in the device has thus to be as compact as possible, in the three dimensions.

Such a heating assembly generally comprises a heat source and a pipe arrangement where the fluid is heated. The pipe arrangement is thus one of the fundamental parts of the heating assembly. The invention, according to a first aspect, aims to provide pipe arrangement optimized in terms of compactness and heating efficiency so as to be usable in a portable hot beverage or food preparation device such as a portable coffee maker.

### SUMMARY OF THE INVENTION

The objective set out above is met with a pipe arrangement for a fluid heating assembly formed of a single heat conductive pipe. The pipe arrangement comprises a stack, along a main axis of the arrangement, of elongate loops of said pipe extending radially from the main axis in directions substantially orthogonal to said main axis. The extension directions of two successive loops form a substantially constant angle between them. The parts of the loops, in the stack, that are proximal in relation to the main axis define a central channel around the main axis.

This particular pipe arrangement makes possible to form a heating column providing a high heating efficiency, in particular when heated with a flame for example from a burner. The central channel makes it possible to guide at least part of the flame within itself, helping heat to be well-distributed along the heating column. The elongate loops extending in radial directions makes it possible to obtain a great pipe length in a compact arrangement, and provides good heating of a fluid flowing in the pipe compared to the known pipe arrangement design such as, for example, a helical winding of the pipe.

In an embodiment of the invention, the stack of elongate loops comprises stages, each stage being formed of three elongate loops, each loop of a stage extending in a direction forming an angle of 120° to 140° with the extension direction of the two other loops of the stage. In this embodiment, each loop of a stage may be offset from the corresponding loop of an adjacent stage by a substantially constant offset angle of 30° to 70° in a plane orthogonal to the main axis.

Each loop of the pipe arrangement may comprise two substantially straight parts linked, at an end that is distal in relation to the main axis, by a substantially semi-circular part. The semi-circular curvature may for example have an inner diameter of 10 to 20 mm, and preferably about 16 mm. The central channel may define a cylinder having a diameter of 5 to 15 mm, and preferably about 10 mm.

The pipe of the pipe arrangement may contact itself each time it crosses itself. This provides a compact pipe arrangement.

The pipe is preferably made of a flame-resistant material such as copper, copper alloy, or stainless steel.

For example, the pipe may have a length of 1 to 5 meters, and preferably about 3 meters and the pipe as an external diameter of 3 to 6 mm, and preferably about 4 mm and, and a wall thickness of about 0.5 mm.

The invention also relates to a fluid heating assembly comprising, in a position for use, a pipe arrangement as previously described and a heat source situated under the pipe arrangement, wherein the heat source comprises a flame generator. The flame generator may be configured to produce a flame at least partially included in the central channel of the pipe arrangement.

The fluid heating assembly may further comprise a plate substantially orthogonal to the main axis of the central channel and is interposed in said channel. The plate may preferably be situated substantially midway between an end of the channel near the flame generator and an opposite end of said channel. This plate blocks the flame and/or heat which rises in the central channel, and prevents it from escaping through the top (i.e. the end opposite to the heat source) of said channel. This increases the heating efficiency of the heating assembly.

The flame generator may for example be a gas burner configured to produce, through a plurality of holes, a flame having a diameter of 20 mm to 50 mm, and preferably about 35 mm. It may for example have a power of 1 kW to 3 kW, and preferably about 2 kW.

The invention finally relates to a portable hot beverage preparation machine comprising a fluid heating assembly as previously described and a gas tank. The gas tank may have a nominal capacity of 20 grams to 100 grams of gas.

### BRIEF DESCRIPTION OF THE DRAWINGS

Additional features and advantages of the present invention are described in, and will be apparent from, the description of the presently preferred embodiments which are set out below with reference to the drawings in which:

FIG. 1 is a schematic partial to view of an example of a pipe arrangement according to an embodiment of a first aspect of the invention;

FIG. 2 is a schematic view in three dimensions of the example part of pipe arrangement of FIG. 1;

FIG. 3 is a general view of the example pipe arrangement of FIG. 2;

FIG. 4 is a schematic illustration of a method for obtaining the pipe arrangement of FIG. 3;

FIG. 5 is a schematic view of a fluid heating assembly according to an example embodiment of a second aspect of the invention.

FIG. 6 is a schematic representation in the form of a graph of the heating performance of the fluid heating assembly of FIG. 5.

FIG. 7 is a schematic representation of a portable beverage preparation machine according to a third aspect of the invention.

### DETAILED DESCRIPTION OF THE INVENTION

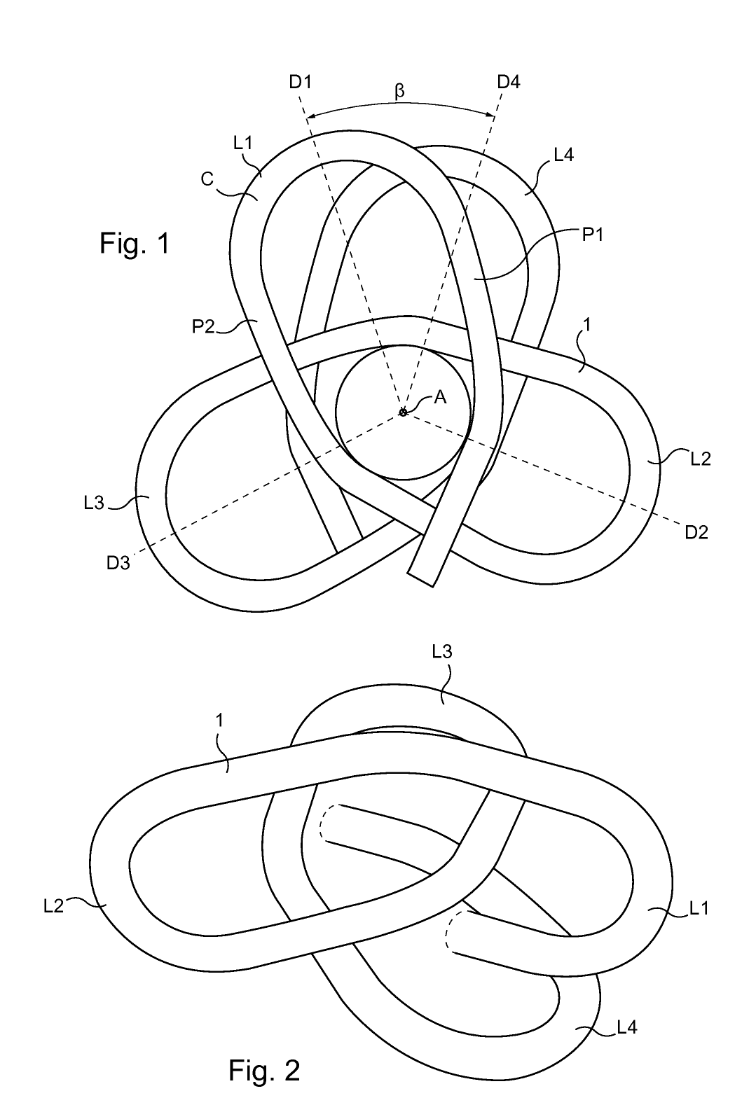

FIG. 1 is a partial top view of an example of a pipe arrangement according to an embodiment of a first aspect of the invention. The pipe arrangement comprises a single pipe 1 which is curved to form a stack of elongate loops. The stack of loops extends along a main axis A. Four elongate loops, namely a first loop L1, a second loop L2 a third loop L3 and a fourth loop L4 are represented on FIG. 1. However, a pipe arrangement according to the invention generally comprises more than four loops. The loops are designated first, second, third and so on according to their position along the curved pipe.

Each elongate loop (L1, L2, L3, L4) extends radially from the main axis A in a direction substantially orthogonal to said main axis A. The first loop L1 extends in a first direction D1. The second loop L2 extends in a second direction D2. The third loop L3 extends in a third direction D3. The fourth loop L4 extends in a fourth direction D4.

In the represented embodiment, each elongate loop comprises two substantially straight parts P1, P2 extending substantially symmetrically on both sides of the extension direction of the elongate loop. The substantially straight parts P1, P2 of a loop are linked, at a distal end from the main axis, by a part of substantially semi-circular curvature of the pipe whose centre is crossed by the extension direction of the elongate loop. Other geometries of loops are possible. For example, the substantially straight parts P1, P2 may in fact be slightly curved to be smoothly linked to the semi-circular part C on one side, and to a substantially straight part of a next loop on the other side.

The angle between the extension directions of two successive loops is, in the represented embodiment, substantially equal to 130°. Thus, the stack may be seen as a succession of stages consisting of three successive elongate loops, each stage been offset from the preceding of an offset angle β of about 30°. In other words, the corresponding loops of two successive stages, for example the first loop L1 and the fourth loop L4, extend in radial directions which are offset of 30°, i.e. the projection of the first direction D1 and the projection of the fourth direction D4 in a plane orthogonal to the main axis form an offset angle β of 30°.

Another way to obtain the desired offset angle is to provide, for a stage consisting of three elongate loops, a 120° angle between the extension directions of two consecutive loops of the same stage, and to provide the desired offset angle between the last loop of a stage and the first loop of the next stage (i.e. providing a 120° plus the value of the offset angle between these extension directions).

Of course, many offset angles typically from 0° to 90°, and preferably from 30° to 70° may be provided. A 0° offset angle corresponds to the case where the corresponding loops of successive stages are aligned.

The offset angle β is preferably constant between each stage. The offset angle β between the corresponding loops of two stages along the main axis is preferably always in the same direction (clockwise or counterclockwise), providing a helical arrangement of the corresponding loops of the stages around the main axis A. If the offset angle is constant, the corresponding loops of the successive stages have a helical arrangement having a constant pitch.

The pipe arrangement forms a channel around the main axis A. In a preferred embodiment, the stack of loops defines a generally cylindrical channel defining a straight cylinder having the main axis A of the arrangement for main axis. In other embodiments, the stack of loops may define a substantially frustoconical shaped channel.

FIG. 2 is provided for a better understanding of the pipe arrangement partially represented in FIG. 1. FIG. 2 is a partial schematic view in three dimensions of the example portion of the pipe arrangement of FIG. 1. The four elongate loops L1, L2, L3, L4 are shown in FIG. 2. However, for a better understanding of FIG. 2, the first elongate loop L1 is only partially represented, starting from the end of one of its substantially straight parts.

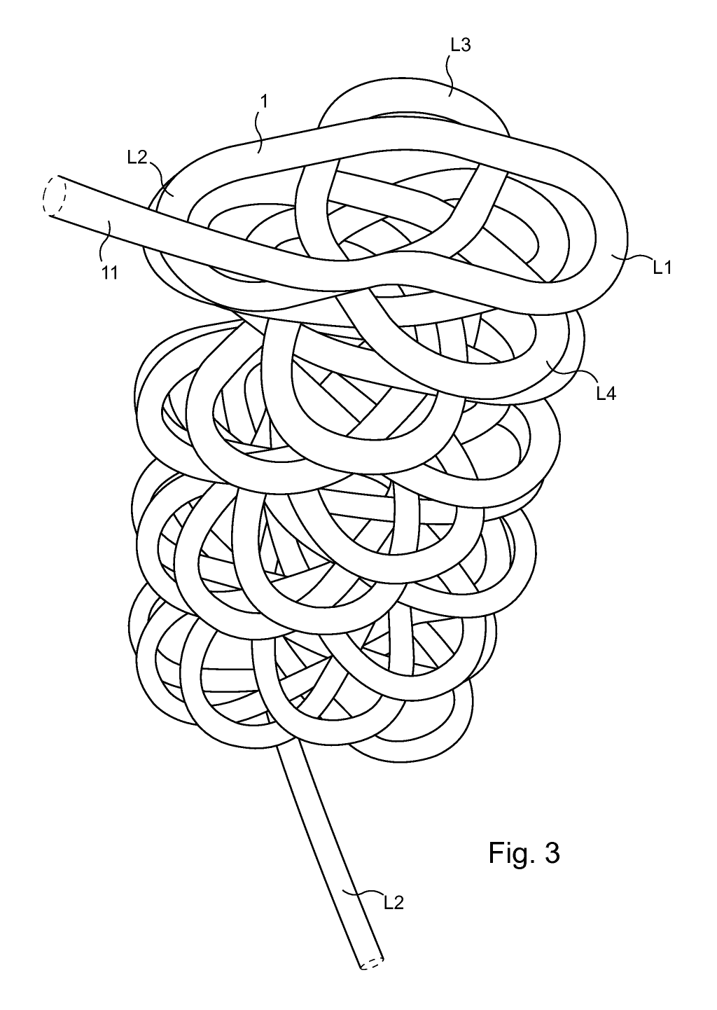

FIG. 3 is a general view of the example pipe arrangement of FIG. 2. In the represented pipe arrangement, more than ten stages of three elongate loops are provided with a helical arrangement. The pipe 1 forming the pipe arrangement shown in FIG. 3 comprises an inlet 11 and an outlet 12. The inlet 11 corresponds to the extreme part of the pipe 1 in which fluid to be heated enters (when the pipe arrangement is used in a fluid heating assembly). The outlet part 12 corresponds to the extreme part of the pipe 1 from which the heated fluid exits. The pipe arrangement is also called a heating column, because it is configured to be used in a heating unit with the main axis A substantially vertically positioned. It provides a vertical accumulation of loops, providing a high number of loops in a small vertical dimension, while allowing air circulation into the column, around the loops.

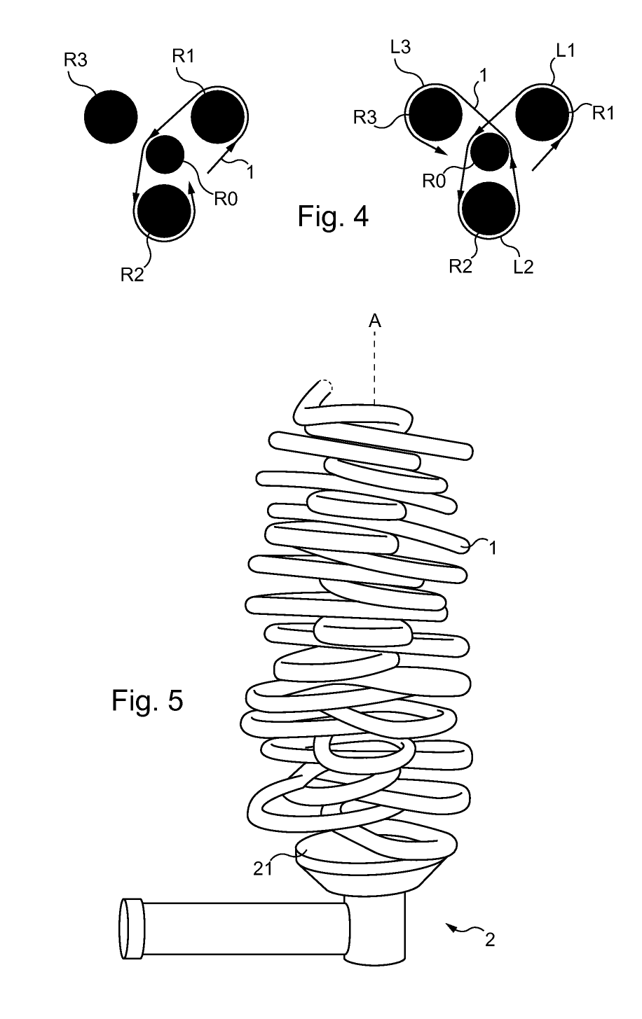

FIG. 4 is a schematic illustration of a method for obtaining the pipe arrangement of FIG. 3. The pipe 1 is represented with arrows that illustrate the progression direction of the pipe within a curving tool.

The method exemplified in FIG. 4 for forming a pipe arrangement comprises:
Providing a curving tool as represented in FIG. 4 and comprising a central cylindrical rod R0 and a first, a second and a third cylindrical grooved rods R1, R2, R3 (provided with a helical groove adapted to guide the pipe) which are parallel to the central rod R0 and disposed at the same distance from the main axis of the central rod, the angle between the axis of two grooved rods and the main axis of the central rod being substantially 120′;
Providing a pipe 1 and;
While rotating the three grooved rods R1, R2, R3 in the same direction and at the same rotation speed:
   a) winding the pipe 1 around the first rod R1 to form a semi-circular pipe curvature, and then
   b) guiding the pipe around the central rod R0 to then make the pipe 1 reach the second grooved rod R2,
   c) forming a semi-circular pipe curvature by winding it around the second grooved rod R2,
   d) guiding the pipe around the central rod R0 to reach the third grooved rod R3;
   e) forming a semi-circular pipe curvature by winding it around the second grooved rod R2;
   f) guiding the pipe around the central rod R0 to reach the first grooved rod R1;
Repeating steps a) to f) until a desired pipe arrangement has been formed.

In such a method, the rods guide the progressive curving of the tube in the three dimensions. The pipe is guided in planes parallel to the main axis of the rod by its winding around them while the grooves of the rods guide the pipe in its progression in the direction of the axis of the rods (generally along the vertical direction).

FIG. 5 is a schematic view of a fluid heating assembly according to an example embodiment of a second aspect of the invention. In a general manner, the heating assembly comprises a heat source and a pipe arrangement as previously described.

Regarding the pipe arrangement, the represented embodiment of pipe arrangement has elongate loops that contact when the pipe crosses itself to reduce as much as possible the size of the pipe arrangement in the direction of the main axis A.

The heat source may be a flame generator such as a gas burner 2, as in the represented embodiment. The pipe arrangement is situated above the gas burner. The gas burner is oriented to generate a substantially vertical flame. In the represented example, the gas burner comprises a cap 21 comprising multiple holes. The cap 21 is substantially horizontally oriented.

The main axis A of the arrangement is vertically arranged. The flame generated by the burner may thus enter the central channel formed around the main axis A of the pipe arrangement. The channel makes it possible to guide and distribute heat from the bottom (near the burner) to the top of the pipe arrangement. A plate (not visible) substantially orthogonal to the main axis A is interposed in the central channel. The plate blocks the flame and/or heat which rises in the central channel, and prevents too much heat to from escaping through the top (i.e. the end opposite to the heat source) of said channel. The plate is thus made of a heat resistant material, and preferably of a flame resistant material. The plate is preferably in metal, such as copper, copper alloy, steel or stainless steel. The plate may preferably be situated substantially midway between an end of the channel near the gas burner 2 and an opposite end of said channel. The plate is in contact with the pipe arrangement to evacuate heat by conduction in the pipe 1.

The burner 2, or, more generally, the used heat source, is preferably as flat as possible to limit the vertical dimension of the heating assembly. For example, the burner 2 of the represented embodiment is about 40 mm high. It produces a flame through the cap 21 which has a 35 mm diameter.

The pipe 1 of the pipe arrangement must resist the heat generated by the heat source. In particular, when the heat source is a flame generator, the pipe 1 must be flame resistant. The pipe 1 is thus preferably metallic. It may be composed of copper, copper alloy such as brass, steel and preferably stainless steel, or stainless steel alloy.

Typical dimensions of the heating assembly may be the following, which corresponds to the dimensions of the embodiment represented in FIG. 5. The pipe 1 is about 3 meters long. The pipe has an external diameter of 4 mm and an internal diameter of 3 mm. The central channel of the pipe arrangement defines a cylinder having a 10 mm diameter. The semi-circular part of each elongate loop has an internal diameter of 16 mm. The obtained height of the pipe arrangement is 105 mm. The width of the pipe arrangement (i.e. its greatest dimension in a direction orthogonal to its main axis A) may be about 40 mm.

These dimensions make it possible to prepare a hot beverage such as a 15 cl coffee in less than 30 seconds, with a water flow of 5.5 grams per second and a burner having an output of about 2 kW.

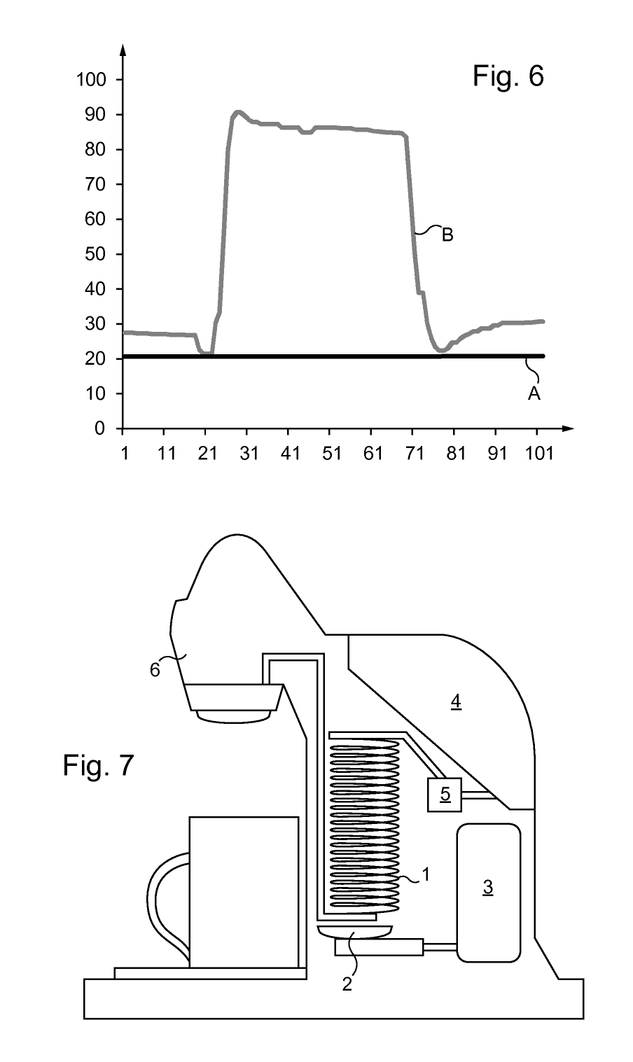

FIG. 6 is a schematic representation in the form of a graph of the heating performance of the fluid heating assembly of FIG. 5, the burner having a 2.3 kW output. The horizontal axis represents the time elapsed in seconds, the vertical axis a fluid temperature in degrees Celsius (° C.). Curve A represents the water temperature at the inlet of the pipe 1; curve B represents the water temperature at the outlet of the pipe 1. In the represented example, heating starts about 11 seconds after the beginning of the measurements. The water introduced into the heating assembly (curve A) at 5.5 grams per second has an almost constant temperature of 18° C. to 19° C. Almost instantly (in less than 5 seconds) the water temperature at the outlet reaches about 90° C. The water temperature at the outlet is maintained at this temperature until the heating is stopped, after about 70 seconds, i.e. about 81 seconds after the beginning of the measurements. The water temperature at the outlet then drops quickly. The efficiency of the represented heating system may be up to around 70%.

During the represented test, 385 g (i.e. 38.5 cl) of water at about 90° C. was delivered in 70 seconds. This shows that the provided dimensions of the heating assembly are compatible for use in a portable beverage machine as represented in FIG. 7.

The represented portable beverage preparation machine uses capsules containing ingredients (e.g. ground coffee) to be extracted or to be dissolved. The beverage may be prepared by inserting a capsule into the beverage machine. More particularly, the machine comprises a receptacle for accommodating said capsule and a fluid injection system for injecting a fluid, preferably water, under pressure into the capsule. The machine is provided with means for storing and heating water, introducing the heated water into the capsule to create a beverage, and dispensing the beverage into a container for consumption.

More particularly, the portable beverage machine of FIG. 7 comprises a heating assembly as previously described, comprising a curved pipe 1 and a burner 2. The burner is fed by a gas tank 3. The gas used may be for example butane or propane, or a mix of butane and propane. For example, a mix comprising 70% butane and 30% propane may be used. The gas tank may be an exchangeable gas cartridge. In most applications, a small tank is sufficient. For example, a cartridge containing 25 grams of gas makes it possible to prepare up to 15 coffees of about 18 cl.

The machine comprises a fluid tank, generally a water tank 4. The water tank provides water to the inlet 11 of the pipe arrangement of the fluid heating assembly. The inlet 11 is preferably at the top of the pipe arrangement, the burner 2 being at its bottom. This maximizes the heating efficiency of the pipe assembly.

The heating assembly may be completely or partially contained in a heat insulating chamber.

A pump 5 makes water circulate in the beverage preparation machine, from the water tank 4 to an extraction head 6 of the machine where a capsule is inserted for beverage (e.g. coffee) preparation by injection of hot water into it. The pump may be a manually actuated pump, or an electric pump powered by a replaceable or rechargeable battery.

It should be understood that various changes and modifications to the presently preferred embodiments described herein will be apparent to those skilled in the art. Such changes and modifications can be made without departing from the spirit and scope of the present invention and without losing its attendant advantages. It is therefore intended that such changes and modifications be covered by the appended claims.

For example, in a beverage preparation machine according to the third aspect of the invention, many types of heat sources or pumps may be used. Many materials may be used to constitute the pipe of the pipe arrangement, as long as they are compatible with the heat level to which it is exposed, and that other criteria such as food contact compatibility are met. The size and characteristics of the components (e.g. pipe length and diameter, size of the burner, flame temperature) may be highly variable depending on the embodiment of the invention and its purpose.

1. A pipe arrangement for a fluid heating assembly formed of a single heat conductive pipe:
comprising a stack, along a main axis of the arrangement, of elongate loops of the pipe extending radially from the main axis in directions substantially orthogonal to the main axis;
the extension directions of two successive loops forming a substantially constant angle between them; and
the parts of the loops, in the stack, that are proximal in relation to the main axis defining a central channel around the main axis.

2. A pipe arrangement according to claim 1, wherein the stack of elongate loops comprises stages, each stage being formed of three elongate loops, each loop of a stage extending in a direction forming an angle of 120° to 140° with the extension direction of the two other loops of the stage.

3. A pipe arrangement according to claim 2, wherein each loop of a stage is offset from the corresponding loop of an adjacent stage by a substantially constant offset angle of 30° to 70° in a plane orthogonal to the main axis.

4. A pipe arrangement according to claim 1, wherein each loop comprises two substantially straight parts linked, at an end that is distal in relation to the main axis, by a substantially semi-circular part.

5. A pipe arrangement according to claim 4, wherein the semi-circular part has an inner diameter of 10 to 20 mm, and the central channel defines a cylinder having a diameter of 5 to 15 mm.

6. A pipe arrangement according to claim 1, wherein the pipe contacts itself each time it crosses itself.

7. A pipe arrangement according to claim 1, wherein the pipe is made of a flame-resistant material.

8. A pipe arrangement according to claim 1, wherein the pipe has a length of 1 to 5 meters and the pipe as an external diameter of 3 to 6 mm and a wall thickness of about 0.5 mm.

9. A fluid heating assembly comprising, in a position for use, a pipe formed of a single heat conductive pipe comprising a stack, along a main axis of the arrangement, of elongate loops of the pipe extending radially from the main axis n directions substantially orthogonal to the main axis, the extension directions of two successive loops forming a substantially constant angle between them, and the parts of the loops, in the stack, that are proximal in relation to the main axis defining a central channel around the main axis and a heat source situated under the pipe arrangement, wherein the heat source comprises a flame generator.

10. A fluid heating assembly according to claim 9, wherein the flame generator is configured to produce a flame at least partially included in the central channel of the pipe arrangement.

11. A fluid heating assembly according to claim 9 comprising a plate substantially orthogonal to the main axis of the central channel and is interposed in the channel.

12. A fluid heating assembly according to claim 11, wherein the plate is situated substantially midway between an end of the channel near the flame generator and an opposite end of the channel.

13. A fluid heating assembly according to claim 9, wherein the flame generator is a gas burner configured to produce, through a plurality of holes, a flame having a diameter of 20 mm to 50 mm.

14. A portable hot beverage preparation machine comprising a fluid heating assembly comprising, in a position for use, a pipe formed of a single heat conductive pipe comprising a stack, along a main axis of the arrangement, of elongate loops of the pipe extending radially from the main axis n directions substantially orthogonal to the main axis, the extension directions of two successive loops forming a substantially constant angle between them, and the parts of the loops, in the stack, that are proximal in relation to the main axis defining a central channel around the main axis and a heat source situated under the pipe arrangement, wherein the heat source comprises a flame generator and a gas tank.

15. A portable hot beverage preparation machine according to claim 14, wherein the gas tank has a nominal capacity of 20 grams to 100 grams of gas.
